(19) United States
(12) Patent Application Publication
(10) Pub. No.: US 2010/0176953 A1
(43) Pub. Date: Jul. 15, 2010

(54) Orientation System And Method

(76) Inventors: Darryl Mark Sherwood, Christchurch (NZ); Brevan Weiss, Panorama (AU); Laurence Peter Freeman, Christchurch (NZ)

Correspondence Address: JOHN ALEXANDER GALBREATH, 2516 CHESTNUT WOODS CT, REISTERSTOWN, MD, 21136, US

(21) Appl. No.: 12/663,265

(22) PCT Filed: Jun. 13, 2008
(86) PCT No.: PCT/NZ08/00142

§ 371 Date: Dec. 4, 2009

(30) Foreign Application Priority Data
Jun. 15, 2007 (NZ) 555918

(51) Int. Cl. G08B 23/00

(52) U.S. Cl. 340/573.1

(57) ABSTRACT

An orientation system for a visually impaired user which includes a base station and a handset; said base station is attached close to an item that the user wishes to orientate themselves to; the base station is configured to emit a beam which is unable to penetrate solid objects and which has a centreline; the handset is configured to detect the beam and generate an output which the user can use to determine the edges of the beam and thus orientate approximately with the centreline.

### FIELD OF THE INVENTION

The present invention is an orientation system and method for a visually impaired user, whether that visual impairment is caused by a physical disability of the user and/or an adverse environmental condition. The invention allows the user to orient themselves to an object or means of egress.

### BACKGROUND

For clarity within this document the term ‘visual impairment’ includes visual impairment caused by physical disability and/or adverse environmental conditions (such as smoke, low illumination or mist).

When a person is visually impaired it can be difficult for them to orient themselves and move towards a means of egress, whether they can locate that means of egress or not. There are devices which assist a visually impaired user in locating items such as entrances, exits, doorways, stairs, elevators, kiosks, vending machines, phones, bus stops and the like, however they do not assist the user in orienting themselves to these items. For example, a person may wish to exit a building where they know, or can locate, the exit, but have no idea what orientation they are in with relation to that exit. A person may approach at an oblique angle to the exit and therefore risk banging into the edge of that exit, with injury or embarrassment the result. In addition if the orientation of the user approaching an item is unknown, the owner of the item must keep all approach paths clear to avoid accidents, and this is often not possible.

Location systems in use at present are often on all the time to allow a user to locate them; this requires the device to be hard wired to the power supply so that continuous activity is ensured. Hard wired systems incur the wiring and labour costs to install and act as a barrier to use by home users.

Some location systems use GPS or radio signals to indicate the position of an item, but since radio waves are not stopped by many solid walls, though the location is known a route to that item is not. To overcome this problem the user needs to be provided with a map of the surrounding area and a non-visual way of accessing this route map. This may involve providing audio and/or tactile instructions (for example “turn right now”). If the mapped area changes, the item provider must update the route map; this can be time consuming and/or expensive. In addition though the system may be accurate enough to locate the item generally, the directions may not be precise enough to prevent a user running into objects along the way. For example commonly available GPS systems are generally only accurate to within 3 metres.

Other systems for a visually impaired user provide a handset which receives information from a transmitter located near an item. This information is then converted to an audio or tactile output advising the user what the item is. There is no information provided to the user to allow them to properly orientate themselves to the item.

If a visually impaired user is in an unfamiliar location, such as a hotel/motel they need to spend some time determining the layout and orientation of doors and other items so they can navigate. Due to the cost of providing location devices a hotel/motel owner is unlikely to install such devices in all areas, or in fact in any areas; this leaves the visually impaired user disadvantaged.

If an area becomes filled with smoke or fumes a person within that area can find themselves disoriented and unable to see, stumbling about. The illuminated exit signs may be visible but if the smoke is acrid even these may not help. An audible signal from the sign may help to guide someone to an exit but the path may not be clear of obstacles.

Any discussion of the prior art throughout the specification is not an admission that such prior art is widely known or forms part of the common general knowledge in the field.

### OBJECT OF THE INVENTION

The present invention provides an orientation system for a visually impaired user which overcomes one or more of the highlighted disadvantages of present location systems.

The present invention provides an orientation system for a visually impaired user which includes a base station and a handset; said base station is attached close to an item that the user wishes to orientate themselves to; the base station is configured to emit a beam which is unable to penetrate solid objects and which has a centreline; the handset is configured to detect the beam and generate an output which the user can use to determine the edges of the beam and thus orientate approximately with the centreline.

Preferably the handset configured to generate the output only upon detecting the edge of the beam.

Preferably the base station is removeably attached.

Preferably the base station is normally inactive and is configured to emit the beam only after receiving a handset signal which the handset is configured to emit when in use. In a highly preferred form the base station emits the beam for a predetermined time after receiving the handset signal. It is further preferred that the handset signal is a short pulse. In a highly preferred form the handset is configured to transmit the pulse at regular intervals for as long as the handset is in use. Preferably the time delay between pulses is less than the predetermined time that the base station is configured to emit the beam.

Preferably the beam and the handset signal carry data able to interpreted by the handset and base station respectively. Preferably the data sent by the base station includes information relating to the item.

Preferably the data can update an instruction set used to configure the handset or base station, and/or provide information relating to the handset or base station. Preferably this data includes one or more of the following: location information, item information, handset updates and base station updates. In a highly preferred form some or all of the data is encrypted.

Preferably the handset includes at least one first source configured to generate the handset signal, a first receiver configured to receive the beam and one or more output device configured to generate the output. In a highly preferred form the base station includes at least one second source configured to generate the beam and a second receiver configured to receive the handset signal. In a further highly preferred form the or each source is selected from the list consisting of an Infra Red (IR) source, an ultraviolet (UV) source, a visual light source and other electromagnetic radiation sources. In a particularly preferred form the or each source is a light emitting diode (LED).

Preferably the or each output device is configured to provide audio or tactile output. In a highly preferred form the output devices are independently selected from the group consisting of a speech synthesiser, a tone generator, a vibrator, an infra red panel and a panel configured to display Braille or other tactile information.

In a preferred form the handset includes a first processor configured to process a first receiver signal from the first receiver and control the or each output device and/or first source. In a highly preferred form the base station includes a second processor configured to process a second receiver signal from the second receiver and control the second source.

In a preferred form the handset includes a first instruction set and the base station includes a second instruction set, each instruction set is configured to be accessed by the respective processor and modify the processing carried out by that processor.

Preferably each processor is configured to control the intensity and on/off time of the or each source to which it is connected.

Preferably the handset includes one or more input ports configured to allow an external device to communicate with the first processor and/or the first instruction list and/or the or each output device. It is preferred that the or each input port is independently selected from the group consisting of a USB port, a serial port, a firewire port, a wireless connection, an optical connection and an infra red connection. In a highly preferred form the output device is a speech synthesiser and the input port is used to update or change the language used by the handset.

Preferably the centreline of the beam intersects the floor some distance from the base station. In a highly preferred form the centreline intersects the floor at a point which allows the system to orientate and guide the user to a point 500 mm to 1 m from the item.

Typically, the ‘item’ would be e.g. a door, an elevator, an escalator, a vending machine, a kiosk, a reception area, a fire exit, a means of egress, a bus stop, a taxi stand and similar items.

The present invention also includes a method of using the orientation system to allow a user to orientate themselves and move towards an item, this method includes the following steps:
A. The user activates the handset to send out a handset signal;
B. The base station receives the handset signal;
C. The base station wakes up and transmits a beam;
D. The user swings the handset through an arc;
E. The handset activates an output device when it detects the beam;
F. The user continues to swing the handset through an arc to locate the edges of the beam of light;
G. The user estimates the point equidistant from each edge and moves towards this position;
H. The user repeats steps F and G until they arrive at the item.

By way of example only a preferred embodiment of the present invention will now be described in detail with reference to the accompanying drawings in which:

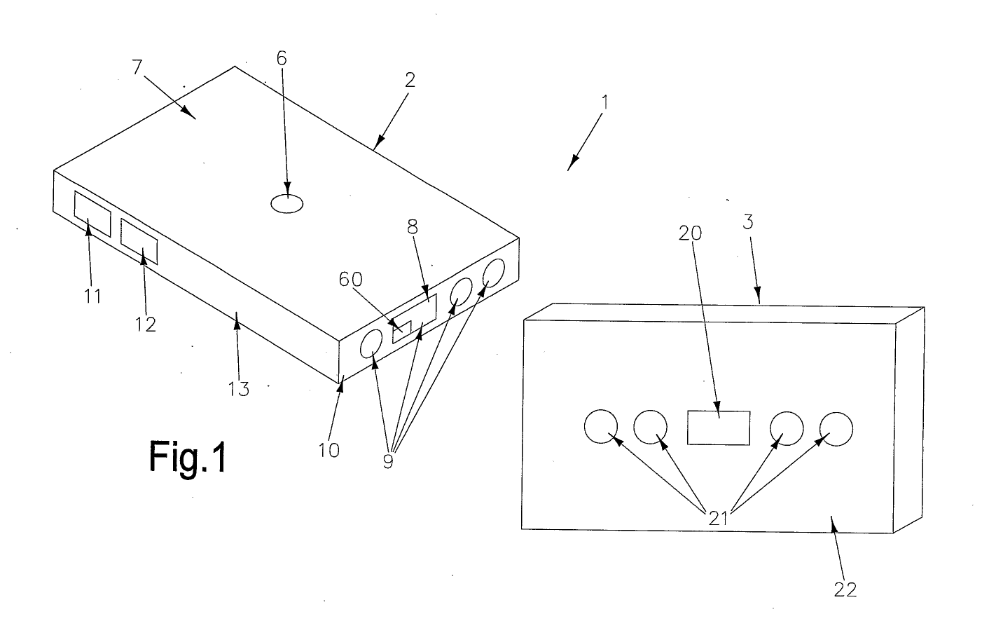

FIG. 1 is an isometric view of the handset and base station;

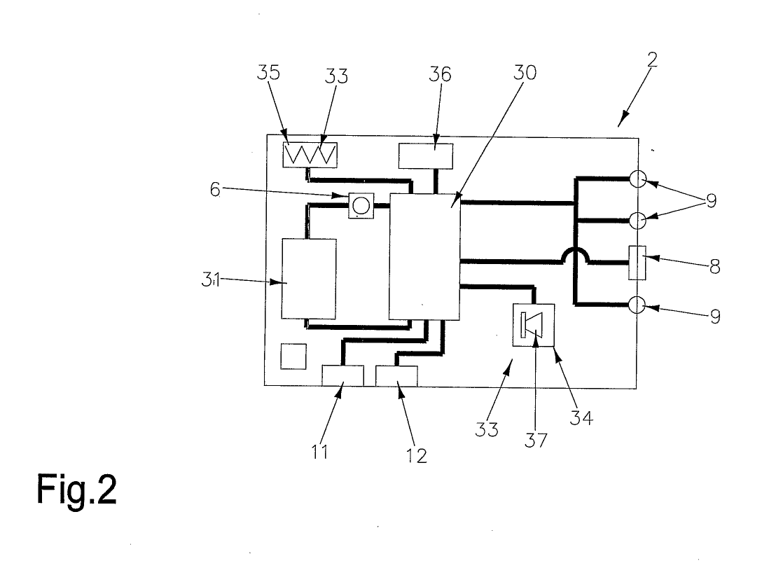

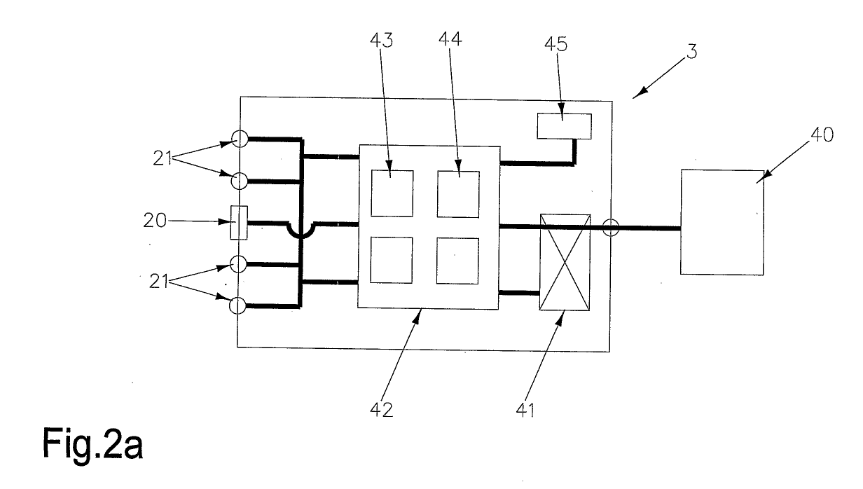

FIG. 2 is a schematic view of the handset;

FIG. 2a is a schematic view of the base station connected to an optional external power supply;

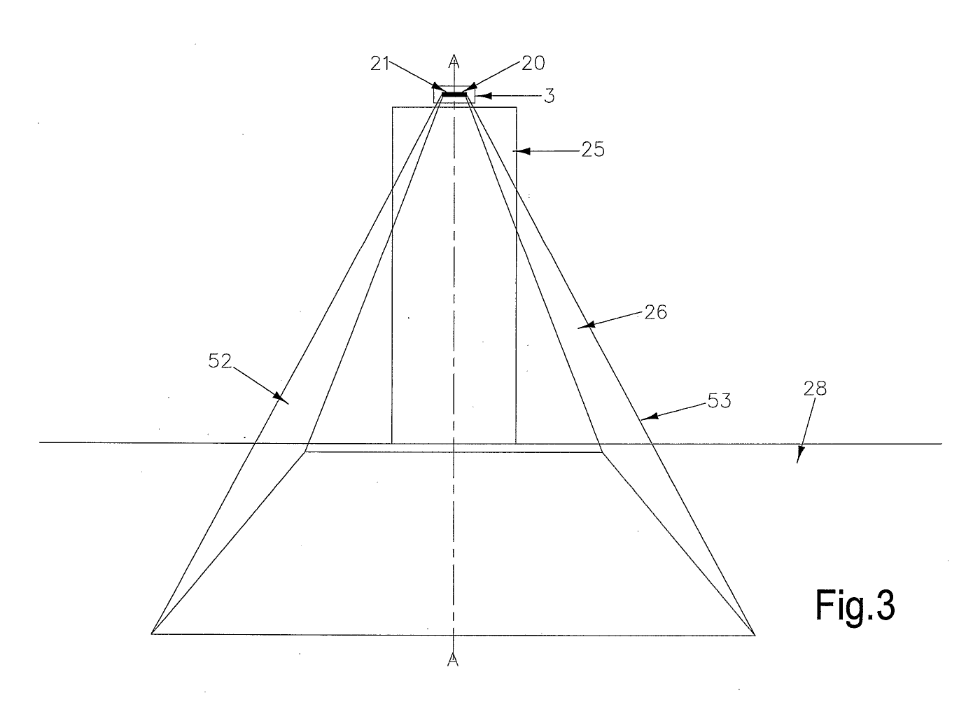

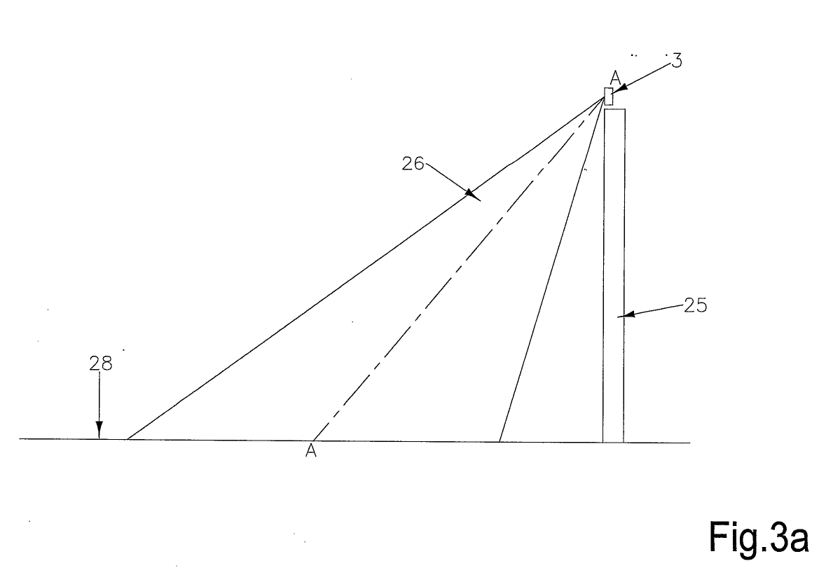

FIG. 3 is a front pictorial view of the base station mounted above a door;

FIG. 3a is a side elevation of the base station mounted above a door.

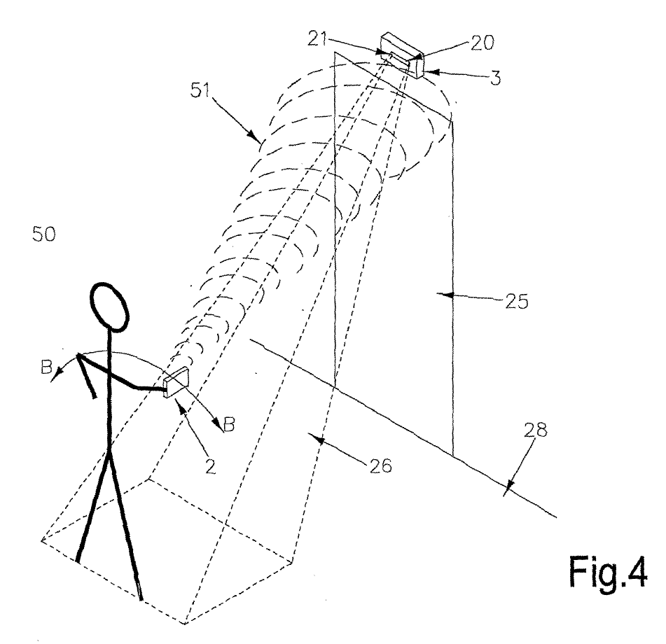

FIG. 4 is a pictorial view of a user using the orientation system to locate a door;

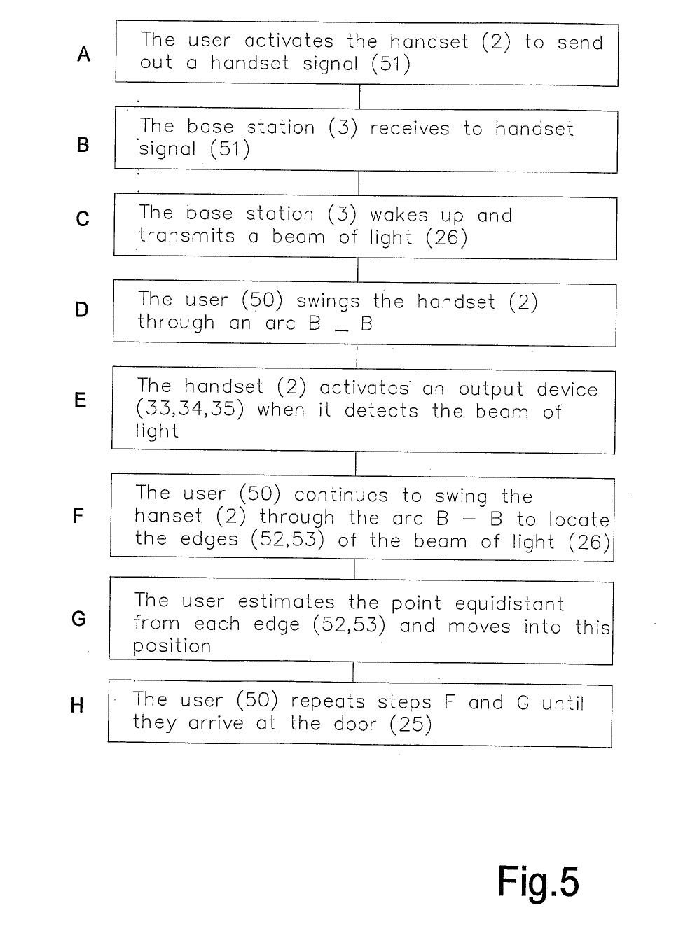

FIG. 5 is a flowchart of a method of using the system to locate a door;

For clarity the following definitions or shortened forms will be used:

### LED=Light Emitting Diode

### IR=Infra Red

### UV=Ultraviolet

### RF=Radio Frequency

### CMOS=Complementary Metal Oxide Semiconductor

### USB=Universal Serial Bus

Referring to FIG. 1 an orientation system (1) for a visually impaired user is shown, said system (1) includes a handset (2) and a base station (3).

The handset (1) is a rectangular prism which includes the following:
a first button (6) located on a first side (7) of the handset (2);
a first receiver (8) and first LEDs (9) located on a first end (10) of the handset (2) and
a first input port (11) and a second input port (12) located on a first edge (13) of the handset (2), such that the first end (10) and first edge (13) are adjacent.
   The first LEDs (9) and first receiver (8) are laid out in linear fashion along the major centreline of the first end (10). The first receiver (8) is located towards the centre of the first end (10) with LEDs (9) located on either side.

The base station (3) is a rectangular prism which includes a second receiver (20) and four second LEDs (21), laid out in linear fashion along the major centreline of a primary side (22) of the base station (3). The second receiver (20) is located in the centre of the primary side (22) with two second LEDs (21) on each side of it.

Referring to FIG. 2 a schematic view of the handset (2) is shown. The handset (2) further includes:
a first processor (30);
a first power source (31), such as a fuel cell or a battery to power the handset (2);
output devices (33), such as an audio device (34) or tactile device (35); and a first instruction list (36).

The first processor (30) incorporates features to minimise the power consumption of the handset (2), this includes setting the mark/space ratio of the first LEDs (9) output, activating only the required components at any one time and using low power CMOS devices. The first processor (30) is connected to the first power source (31), the first LEDs (9), the first button (6), the output devices (33,34,35), the input ports (11,12) and the first receiver (8). The first processor (30) is controlled by the instruction list (36) and internally predetermined settings, such as circuit board design and the components used.

The first instruction list (36) can include instructions for setting the mark/space ratio, otherwise varying the power output by adjusting a signal sent to the first LEDs, decrypting a signal from the first receiver (8) or an input port (11,12), adjust a signal sent to the output devices (33,34,35), timing the use of internal components and controlling an internal charging circuit for the first power source (31).

All or part of the first instruction list (36) can be updated by using the first input port (11); this first input port (11) can be a usb, firewire, ethernet, serial, bluetooth, optical or similar connection. The second input port (12) can be a connection similar to the first input port or a power connector, allowing the first power source (31) to be recharged from an external power supply (not shown). The first instruction list (36) can also be updated by a signal received from the base station (3) or, if the handset (2) is connected to an external power supply, a power line signal.

The first processor (30) controls the output from the or each output device (33,34,35). The audio output device (34) may be a simple tone generator or a speaker capable of high quality sound. The first processor (30) may include a speech synthesiser (37) so that the output from the audio output device (34) is speech. The first instruction list (36) can be used to change the language of the speech synthesiser (37) and extend the vocabulary or modify other parameters. The tactile output device (35) may be a vibrator or a more complex device such as a panel configured to display Braille.

Referring to FIG. 2a a schematic view of the base station (3) connected to an external power supply (40) is shown. The base station (3) further includes:
a second power source (41), which may include a fuel cell or battery, and charging/rectification circuitry, to power the base station (3);
a second processor (42), which includes stored data (43,44); and
a second instruction list (45).
   The second power source (41), second LEDs (21) and second receiver (20) are all connected to the second processor (42). The operation of the second processor (42) is determined by the second instruction list (45) and internally predetermined settings, such as circuit board design and internal components. The second instruction list (45) can include instructions to adjust power settings, control of the signal sent to the second LEDs (21), encryption/decryption of the signal received from the second receiver (20), allow updating of the second instruction list (45), transmit time/intensity of second LEDs (21) and information related to the location of the base station (3).

The base station (3) can be disconnected from the external power supply (40) and moved about, the power is then wholly supplied by the second power source (41).

The first and second power sources (31,41) allow the handset (2) and base station (3) to be portable. Both the handset (2) and base station (3) components (8,9,11,12,20,21,30,33,34,35,42) are low power devices, such as CMOS microprocessors. In addition each instruction list (36,45) includes instructions that further minimise the power consumption of the handset (2) and base station (3), e.g. when to enter a sleep state, duration that the LEDs (9,21) are on, LED (9,21) brightness and output device (33,34,35) output level.

Referring to FIGS. 3 and 3a the base station (3) is shown mounted above an exit (25). The second LEDs (21), when activated, are arranged so that a beam of light (26) is emitted, said beam of light (26) being a truncated pyramid with an approximately rectangular cross section with the major axis approximately parallel to the floor (28). It has been found that by arranging the second LEDs (21) so that there is a spread of light about 70° horizontally (35° along the major axis each side of the beam of light's (26) centreline (A-A)) and about 50° along the minor axis (25° along the minor axis each side of the beam of light's (26) centreline (A-A)) is optimum. In use the base station (3) is arranged so that the centreline (A-A) intersects the floor (28). It has been found that if the edge of the beam of light (26) closest to the door (25) is about 500 mm to 1 m from the door (25) that this is sufficient for most users.

Referring to the Figures the orientation system (1) in operation will be described. The user (50) activates the handset (2) using the first button (6) which causes the first processor (30) to activate the first LEDs (9) and generate a handset signal (51). The user (50) then moves the handset (2) from side to side along an arc B-B with the first LEDs (9) facing forwards; in use the line on which the first LEDs (9) and first receiver (8) lie is approximately perpendicular to the ground (28). When the second receiver (20) receives the handset signal (51) the base station (3) wakes from a sleep condition, typically in 100 ms or less, and activates the second LEDs (21) generating the flat beam of light (26). The second LEDs (21) stay on for as long as the second receiver (20) receives the handset signal (51) and for a predetermined time delay after this.

The first receiver (8) detects the beam of light (26) from the second LEDs (21), the first processor (30) receives this signal, consults the first instruction list (36) and activates an output device (33,34,35) to provide feedback to the user (50). This feedback to the user may be a tone or vibration. The user (50) continues to swing the handset (2) along the arc B-B to determine the edges (52,53) of the beam of light (26). The user then estimates the centre of the beam of light (26) by approximating a point equidistant from the edges (52,53) and moves forwards.

By continuing to swing the handset (2) along the arc B-B and moving forwards the user (50) orientates with the centreline A-A of the beam of light (26). Once the user is aligned with the centreline A-A of the beam of light (26) he can move towards the door (25). If the user (50) is a long way from the door (25) then a wide arc B-B will initially be needed to locate the edges (52,53) then, as the user approaches the door (25), the arc B-B required to locate the edges (52,53) will decrease. This decrease in the arc B-B provides the user (50) with an indication of the distance to the door (25). In addition with the beam of light (26) narrowing as the user approaches the door (25) they are able to orientate themselves more precisely as they get closer. It has been found that with some practice a user (50) can accurately estimate the distance to the door (25) and move quickly towards it without fear. Changing the distance the arc B-B is from the user (50), the user (50) can obtain useful distance information without physically moving.

Referring to FIG. 5 a flowchart is shown which summarises the method of using the orientation system (1) described above. The method includes the following steps in order:
A. The user activates the handset (2) to send out a handset signal (51);
B. The base station (3) receives the handset signal (51);
C. The base station (3) wakes up and transmits a beam of light (26);
D. The user (50) swings the handset (2) through an arc B-B;
E. The handset (2) activates an output device (33,34,35) when it detects the beam of light (26);
F. The user (50) continues to swing the handset (2) through the arc B-B to locate the edges (52,53) of the beam of light (26);
G. The user (50) estimates the point equidistant from each edge (52,53) and moves into this position;
H. The user (50) repeats steps F and G until they arrive at the door (25)

Users (50) have found the orientation system (1) is a quick way of allowing them to mark the exit to a room or align themselves with the centre of a hallway, even in unfamiliar locations. The user arrives in a location, determines where the door (25) is, removeably attaches the base station (3) in a suitable location above the door (25) and can now use the handset (2) to orient to the door (25).

Maintaining the base station (3) in a sleep condition until required minimises the power requirements of the base station (3) until required by a user (50). The sleep to wake time of under 100 ms is perceived as instantaneous to a user (50), so continuously on devices do not offer any advantage.

The handset signal (51) is generated as a pulse of modulated light from the first LEDs (9), with the pulse resent at a predetermined interval for as long as the first button (6) is pressed. This keeps the base station (3) awake for as long as the user (50) requires.

The LEDs (9,21) used at present are IR LEDs, with the frequency chosen to minimise reflected signals which may cause the output devices (33,34,35) to provide incorrect orientation information to the user (50).

The intensity of the LED's (9,21) is modulated by the respective processor (30,42) to carry data between the handset (2) and the base station (3) and vice versa. This intensity may be further adjusted to take account of the ambient conditions.

One use for the orientation system (1) is to assist a user (50) in orientating themselves with a fire exit/means of egress in a fire or environment the similarly reduces vision, for example chemical fumes. In this case handsets (3) could be located around the environment, or carried by each user (50). The advantage here is that the routes to each exit could be kept clear of obstacles and easily found. A further use would be for a temporary hazardous site or smoke/mist filled area, the base station (3) could be located where required and users (50) issued with handsets (2) to navigate through the area. In addition if there is a temporary concert or show the orientation system could be used to guide visually impaired people into the venue.

It should be noted that though the orientation system (1) has been described referring to a single user (50), there can be many users (50) each with a handset (2).

It is envisioned that many of the features of the orientation system (1) could be updated by updating the instruction lists (36,45), by either the user (50) or the manufacturer, this would keep the long term cost of ownership cost low.

In a further embodiment the first receiver (8) includes a transceiver (60) which provides feedback to the user of any obstacles, this can be used to allow the visually impaired user to avoid these obstacles. The transceiver (60) can be an ultrasonic, microwave, UV or IR transceiver adapted to send out a beam and process a received reflected signal to indicate the distance to/location of an obstacle. The transceiver (60) requires a reflected signal from an obstacle to work.

In a further embodiment the base station (3) transmits additional information for the user (50), such as type of item and specific item description. For example it may tell the user (50) that the item is an elevator and the door is open or that it is a drink vending machine or a bus stop with a certain bus due in 5 minutes.

In a further embodiment the output device (33,34,35) provides more than a single tone or vibration. The audio output device (34) includes a speech synthesizer (61) which generates synthesized speech such as warning or information messages. The audio output device (34) could also generate a variable tone depending upon the strength of the signal received by the first receiver (8). The language used by the speech synthesizer (61) could be changed or updated by the first instruction list (36) being updated via an input port (11,12). As the handset (2) language would be that of a user (50) and independent of the location the user (50) can still orientate and navigate.

In a further embodiment the tactile output device (35) is configured to heat or cool to provide feedback to the user (50).

In a further embodiment the second power source (41) is connected and recharged inductively by the external power supply (40). This allows the base station (3) to be completely sealed and portable but still easy to recharge. By completely enclosing the base station (3) and inductively supplying power the opportunity for tampering is reduced.

In a further embodiment the processors (32,42) filter the input from the respective receiver (8,20) to remove ambient or reflected signals: this can be by setting the accepted signal threshold above likely reflected signals' strength, taking a background reading and subtracting this from the received signal or any other known method for removing spurious or reflected signals. To carry out the ambient subtraction the transmitting device, the handset (2) or base station (3), may need to be instructed by the other device, the base station (3) or handset (2), to turn off for a short period while an ambient reading is taken.

In a further embodiment the spread of light along the major and minor axis of the beam of light (26) is between 1° and 180°.

In a further embodiment the handset (2) only generates an output when the edge of the beam of light (26) is detected.

In a still further embodiment the intensity/modulation or other characteristic of the beam of light (26) varies towards the centreline A-A and the handset (2) is configured to locate this. In this embodiment the user (50) is more quickly able to orient themselves. For example the centreline A-A may be highlighted by a highly collimated beam such as that created by a laser.

1. An orientation system for a visually impaired user which includes a base station and a handset; said base station is attached close to an item that the user wishes to orientate themselves to; the base station is configured to emit a beam which is unable to penetrate solid objects and which has a centreline; the handset is configured to detect the beam and generate an output which the user can use to determine the edges of the beam and thus orientate approximately with the centreline.

2. The orientation system as claimed in claim 1 characterised in that the handset is configured to generate the output only upon detecting the edge of the beam.

3. The orientation system as claimed in claim 1 characterised in that the base station is normally inactive and is configured to emit the beam only after receiving a handset signal which the handset is configured to emit when in use.

4. The orientation system as claimed in claim 3 characterised in that the base station emits the beam for a predetermined time after receiving the handset signal.

5. The orientation system as claimed in claim 4 characterised in that the handset signal is a short pulse.

6. The orientation system as claimed in claim 5 characterised in that the handset is configured to transmit the pulse at regular intervals for as long as the handset is in use.

7. The orientation system as claimed in claim 6, characterised in that the time delay between pulses is less than the predetermined time that the base station is configured to emit the beam.

8. The orientation system as claimed in claim 3 characterised in that the beam and the handset signal carry data able to interpreted by the handset and base station respectively.

9. The orientation system as claimed in claim 8 characterised in that the data sent by the base station includes information relating to the item.

10. (canceled)

11. The orientation system as claimed in claim 8 characterised in that some or all of the data is encrypted.

12. The orientation system as claimed in claim 3 characterised in that the handset includes at least one first source configured to generate the handset signal, a first receiver configured to receive the beam and one or more output device configured to generate the output.

13. The orientation system as claimed in claim 12 characterised in that the base station includes at least one second source configured to generate the beam and a second receiver configured to receive the handset signal.

14. The orientation system as claimed in claim 12 characterised in that the or each source is selected from the list consisting of an Infra Red (IR) source, an ultraviolet (UV) source, a visual light source and other electromagnetic radiation sources.

15. (canceled)

16. The orientation system as claimed in claim 12 characterised in that the or each output device is configured to provide audio or tactile output.

17. The orientation system as claimed in claim 16 characterised in that the or each output device is independently selected from the group consisting of: a speech synthesiser, a tone generator, a vibrator, an infra red panel and a panel configured to display Braille or other tactile information.

18. The orientation system as claimed in claim 12 characterised in that the handset includes a first processor configured to process a first receiver signal from the first receiver and control the or each output device and/or first source.

19. The orientation system as claimed in claim 18 characterised in that the base station includes a second processor configured to process a second receiver signal from the second receiver and control the second source.

20. The orientation system as claimed in claim 19, characterised in that the handset includes a first instruction set and the base station includes a second instruction set, each instruction set is configured to be accessed by the respective processor and modify the processing carried out by that processor.

21. The orientation system as claimed in claim 20 characterised in that each processor is configured to control the intensity and on/off time of the or each source to which it is connected.

22. The orientation system as claimed in claim 18 characterised in that the handset includes one or more input ports configured to allow an external device to communicate with the first processor and/or the first instruction list and/or the or each output device.

23. (canceled)

24. The orientation system as claimed in claim 22 characterised in that the handset includes a speech synthesiser and the input port is used to update or change the language used by the speech synthesiser.

25. The orientation system as claimed in claim 1 characterised in that the centreline of the beam intersects a floor some distance from the base station.

26. The orientation system as claimed in claim 25 characterised in that the centreline intersects the floor at a point which allows the system to orientate and guide the user to a point 500 mm to 1 m from the item.

27. The orientation system as claimed in claim 1 characterised in that the item is selected from the list consisting of: a door, an elevator, an escalator, a vending machine, a kiosk, a reception area, a fire exit, a means of egress, a bus stop, a taxi stand and service counter.

28. The orientation system as claimed in claim 1 characterised in that the base station is removeably attached close to the item.

29. A method of using the orientation system as claimed in claim 1 that allows a user to orientate themselves and move towards an item, this method includes the following steps:
A. The user activates the handset to send out a handset signal;
B. The base station receives the handset signal;
C. The base station wakes up and transmits a beam;
D. The user swings the handset through an arc;
E. The handset activates an output device when it detects the beam;
F. The user continues to swing the handset through an arc to locate the edges of the beam of light;
G. The user estimates the point equidistant from each edge and moves towards this position;
H. The user repeats steps F and G until they arrive at the item.

30. The orientation system as claimed in claim 13 characterised in that the base station includes a second processor configured to process a second receiver signal from the second receiver and control the second source.
